(19) United States
(12) Patent Application Publication
(10) Pub. No.: US 2010/0138125 A1
(43) Pub. Date: Jun. 3, 2010

(54) Device and method for monitoring a magnetic brake on rail vehicles

(75) Inventor: Helmut Edlinger, Muenchen (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Schaltbau GmbH, Muenchen (DE)

(21) Appl. No.: 12/622,353

(22) Filed: Nov. 19, 2009

(30) Foreign Application Priority Data
Dec. 1, 2008 (DE) 10 2008 059 882.8

(51) Int. Cl. B61H 7/08; H01F 27/42

(52) U.S. Cl. 701/70; 307/104

(57) ABSTRACT

The present invention relates to a device for monitoring a magnetic brake on rail vehicles, the magnetic brake being connected to a source of voltage for current supply, the device comprising switching on and monitoring of the brake magnet current and the monitoring device including a determining device and an evaluating device, the determining device continuously monitoring the function of the circuit for the current supply to the magnetic brake during braking, and recording the current and/or voltage profile. Here, the evaluating device determines the placement of the magnetic brake on the rail on the basis of the recorded current and/or voltage profile by detection of two zero crossings of the first derivative of the current and/or voltage profile.

The present invention relates to a device for monitoring a magnetic brake on rail vehicles, the magnetic brake being connected to a source of voltage for current supply and the device comprising switching on and monitoring of the brake magnet current, and a method for monitoring a magnetic brake.

A magnetic rail brake is a brake for rail vehicles. As a rule, it consists of sliding shoes made of iron with integrated solenoids. As a rule, the magnet is lowered by compressed air, but the rail will only be contacted after current has been switched on. When current is flowing through the solenoid, the brake shoe is lowered onto the rail and pulled towards the rail, thus pressing against the same due to the magnetic force, i.e., the braking force is achieved through friction.

Friction ensures the braking action, which action is also not noticeably impaired by slippery rails. The braking force itself depends on the holding force, the coefficient of friction of the rail brake-magnet pole shoes, and the air gap or impurities on the rail head and the brake magnet. On account of the braking action achieved through friction, the magnetic brake is subject to great wear and entails high maintenance and repair costs, so that it is normally only used as a quick-acting, emergency or automatic train stopping brake that is activated in dangerous situations.

To remain competitive in comparison with air traffic, one aims at a continuous increase in the travel speed for passenger traffic on rails. However, the higher speeds of corresponding rail vehicles also make increased demands on the brake concept. With a higher initial speed of the brake, the necessary braking power rises on the one hand and the coefficient of adhesion between wheel and rail is decreasing on the other hand. Magnetic rail brakes are here advantageous as they are not only independent of the coefficient of adhesion, but also provide a very high useful braking power, especially also in winter time when the brake systems depending on the coefficient of adhesion cannot be made adequately safe because of leaves or ice.

Nowadays, magnetic brakes are normally restricted to uses as quick acting brakes or emergency brakes. The increasing demands made on the brake concept, however, require the integration of the magnetic brake as a component of the braking power concept.

However, to guarantee this integration, special demands made on the safety and reliability must be satisfied by the magnetic brake. Of decisive importance is here the diagnosis of the magnetic brake that serves to detect the operativeness. Corresponding checking devices must simulate the driver's brake valve position and the speed, according to which the lowering of the magnets and the current supply must be recognizable. As a rule, the lowering operation is controlled through optical detection and must therefore be carried out individually for each car.

DE 20 2007 009 724 U1 discloses a semiconductor switching element for operating magnetic rail brakes. Here, the intensity of the electric current in the rail brake can be set by using one or more power semiconductors, mainly MOS-FET, and a control module, which produces a suitable modulation signal for controlling the semiconductors. In addition, it may be provided that the change in the operating current is evaluated during lowering and engagement of the rail brake as a position report. In this instance, however, no specific devices or evaluation methods are indicated for obtaining the position report in this case.

It is the object of the present invention to provide a device and a method for monitoring a magnetic brake which monitors, and can ensure, the operativeness of the magnetic brake, so that the magnetic brake can be fully attributed to the brake weight, and the total number of brakes can be reduced.

This object is achieved for a device for monitoring a magnetic brake on rail vehicles, the magnetic brake being connected to a source of voltage for current supply, the device comprising switching on and monitoring of the brake magnet current and the monitoring device including a determining device and an evaluating device, the determining device continuously monitoring the function of the circuit for the current supply to the magnetic brake and recording the current and/or voltage profile, in that the evaluating device determines the placement of the magnetic brake on the rail on the basis of the recorded current and/or voltage profile by detection of two zero crossings of the first derivative of the current and/or voltage profile.

Hence, owing to the device according to the invention a diagnosis of the readiness of the magnetic brake system is carried out on the one hand and the braking function is monitored on the other hand; to be more specific, the placement of the braking magnets on the rails is recognized. The function of the magnetic brake is thereby ensured, so that it can be fully attributed to the braking power of the vehicle.

The detection of the zero crossings of the first derivative is here a reliable method for ensuring the braking operation made, irrespective of external influences, e.g. of a change in the support surface of the brake magnet, by which a change in the magnetic field is induced. The device according to the invention thereby permits for the first time a monitoring method that is so reliable that the braking power of the magnetic brakes can be fully attributed to the brake weight.

Since the device according to the invention detects the current flow through the magnet on the one hand and the contact of the magnet with the rail on the other hand, the braking action of the magnetic brake can be deduced. At the same time the device according to the invention permits the reliable and rapid determination of errors or faults in the systems.

The device according to the invention can here be used for an individual magnet, a swivel truck, i.e. two magnets, and also for a car, i.e. two swivel trucks, thereby permitting a wide field of application that can be customized.

According to a preferred embodiment of the invention an electromechanical separator can be arranged as an emergency cutout in the circuit. This permits a rapid deactivation of the brake upon output of error messages.

According to another preferred embodiment the determining device can additionally monitor the individual elements of the circuit, particularly the electromechanical separator, the current sensors, suppressor diodes and switching elements, so that the monitoring device can separately react to any kind of failure and a very short reaction time to faults arising within the device is achieved.

Advantageously, the switching elements may be IGBT modules. Corresponding modules have turned out to be useful in practice. The number of the IGBT modules can be chosen in response to the respective requirements. For instance, one IGBT module each, as well as any other switching element, can be used for a magnet, a swivel truck or a car.

According to a further preferred embodiment each brake magnet can comprise a position sensor, so that in addition to the monitoring operation through detection of the zero crossings the distance between brake magnet and rail head can be detected. Advantageously, the position sensor may here be an inductive, capacitive or optical sensor.

According to another embodiment it may be provided that each brake magnet comprises a thermometer. The use of additional magnets provides a further additional monitoring method that describes the contact of the magnet with the rail.

Furthermore, a thermosensor may be arranged in front of and behind each brake magnet so as to detect the placement of the magnet through the change in temperature in front of and behind the magnet. The sensor is here not arranged on the carrier of the magnet, so that the service life and maintenance of the sensor can be improved.

According to another preferred embodiment each brake magnet may be arranged in a circuit of its own so as to achieve results as accurate as possible for each individual magnet. Upon an error message the error can thereby be allocated and eliminated more rapidly.

As for the method, the invention is accomplished through a method for monitoring a magnetic brake on rail vehicles, comprising the continuous monitoring of the function of the circuit for current supply to the magnetic brake, and recording the current and/or voltage profile, in that on the basis of the recorded current and/or voltage profile the placement of the magnetic brake on the rail is determined by detection of two zero crossings of the first derivative of the current and/or voltage profile.

The method according to the invention provides for a reliable monitoring of the magnetic brakes that is independent of external influences and can rapidly react to faults or errors found in the circuit.

Advantageously, the current flow can be measured at time constant intervals of 1 to 30 milliseconds. Corresponding time intervals have turned out to be particularly suited in practice.

According to a preferred embodiment the current path of each brake magnet can be monitored separately so as to be able to make a statement on each brake magnet.

Furthermore, the current can be measured in the outgoing line and return line; this enhances the accuracy of the measurement especially since every magnet is checked individually, and the critical case of a one-sided braking action, e.g. due to line breakage in a magnetic circuit, can be prevented.

Advantageously, the supply voltage and the intrasystem voltages are cyclically measured in the magnetic circuit. This permits a very short fault detection time.

According to a further preferred embodiment brake tests may be carried out at predetermined intervals. The function of the brake as well as the brake monitoring action can thereby be checked. At the same time, the brake test yields a current curve that can be compared with the current curves of normal braking operations.

Advantageously, the individual elements of the circuit can be monitored in addition, and a diagnosis of every single element can be made, whereby error detection times that are as short as possible can be achieved.

A preferred embodiment of the present invention shall now be explained with reference to the attached drawing, in which

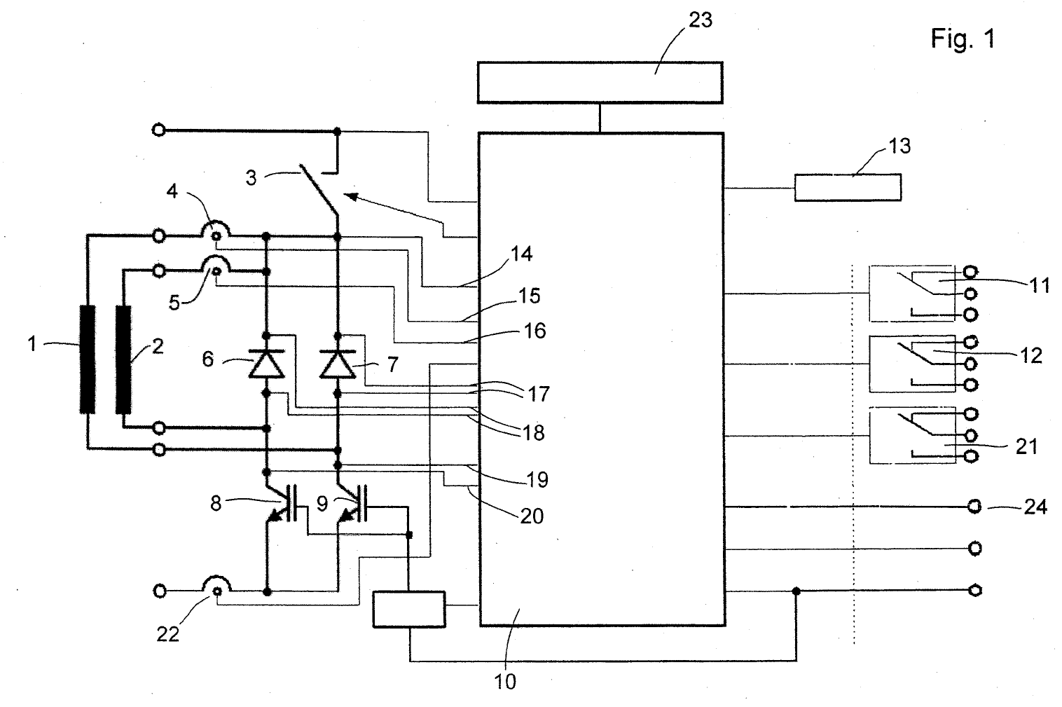

FIG. 1 shows a circuit of a device according to the invention;

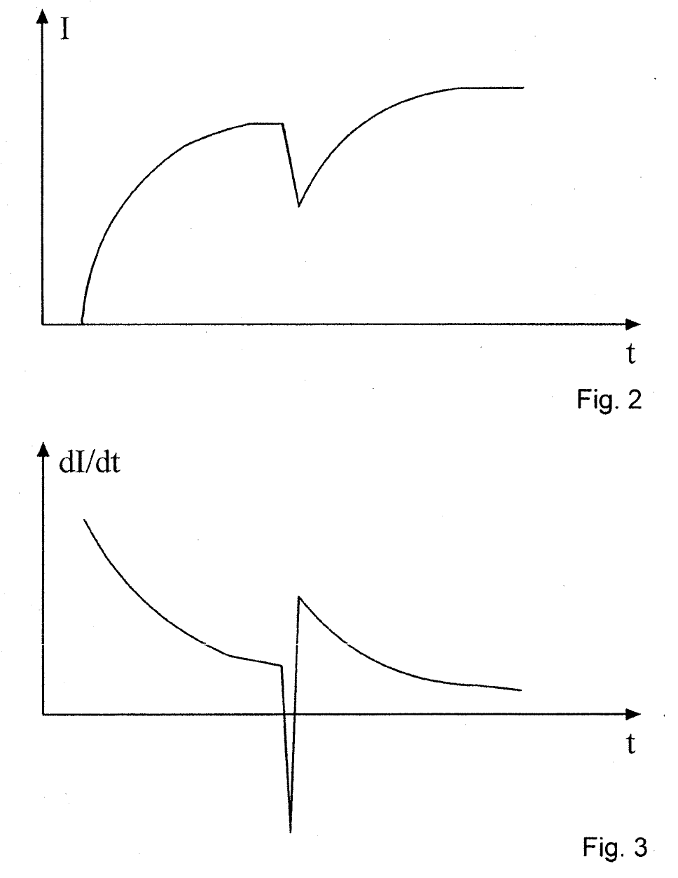

FIG. 2 is a schematic illustration of the curve of the current flow during current supply to the magnetic brake and placement of the brake on the rails;

FIG. 3 is a schematic illustration of the derivative of the current curve of FIG. 2.

FIG. 1 shows the magnetic brake monitoring according to the invention. The monitoring system is here divided into two electrically isolated parts, the high-current part and the monitoring part. Both circuit parts may be configured as separate printed circuit boards. They are interconnected via a connector.

The high-current part connects the vehicle battery to the brake magnets 1, 2. Both brake magnets are directly connected to the positive terminal of the battery voltage. In the current path, an electromechanical separator 3, e.g. a contactor, is arranged between the vehicle battery and the brake magnet, for separating the positive battery potential from the device and thus also the magnet in case of fault. This separator 3 is driven via the evaluation circuit. The separator 3 can be equally driven via a master control unit.

The separator 3 is followed by the current paths for the two brake magnets 1, 2, which are separately guided, but are each of identical structure. Each of said paths includes a current sensor 4, 5, e.g. current transformer or shunt, and then leads to the positive terminal of the magnet.

The cable led from the negative terminal of the magnet is connected to a further connecting point of the magnet monitoring system.

Between the two connecting points, plus and minus of the magnets, a suppressor diode 6, 7 is positioned in the device as a freewheeling circuit. Said diode takes over the current flow through the magnet at the switch-off time.

The negative terminal of the magnet is connected via a switching element 8, 9 to the negative terminal of the vehicle battery. Said switching element 8, 9 is used for the operative switching on of the brake magnets 1, 2. It is expediently a semiconductor device, e.g. an IGBT. The switching elements 8, 9 of both magnetic circuits are switched at the same time, both upon activation and deactivation.

The individual elements of each path of the magnets 1, 2, i.e. current sensor 4, 5, suppressor diode 6, 7, IGBTs 8, 9, etc., are separately monitored with respect to one another. According to another embodiment of the invention both magnets of a pair may also be monitored via a shared evaluation. As a result, the wiring efforts as well as the number of the necessary elements can be kept small because only one cable for positive and negative terminal of the magnets must be passed to the swivel truck.

Furthermore, the current sensors 4, 5 could also be arranged after the negative terminal of the brake magnets, preferably between this terminal and the freewheeling diode integrated in the IGBT module 8, 9.

The current is measured for each magnet in the outgoing line.

In addition, current may also be measured for both magnets together in the return line. To this end an additional current sensor 22 is provided behind the IGBTs 8, 9. In the line of the current sensor 22 a redundant measurement of the total current is carried out, whereby the function of all current meters can be monitored.

Although in the illustrated embodiment only one current sensor is provided in the return line, it is also possible to use two, i.e. one for each magnet, thereby improving fault allocation. The additional current sensor 22 increases the accuracy of the total system because errors or faults can be allocated more accurately.

Reference numeral 10 designates the monitoring unit. This monitoring unit serves to evaluate the system states in the magnetic brake monitoring system. The evaluation circuit is fed via the battery of the vehicle. The battery voltage is protected via a fuse in the device. On the basis of this battery supply voltage, a power supply unit 23 generates the secondary voltages needed in the circuit for the electronic equipment.

The switch-on command is given via circuit inputs which are also electrically isolated from each other. There are respectively separate inputs for the braking action and the brake test. The brake is directly activated via the hardware. The transmission of the switch-on information to the processor only serves to inform the processor on the state of the system.

As signal output, electrically isolated contacts serve to indicate the system state. As separating elements, relays 11, 12, 21 may for instance be used. The solution shown in FIG. 1 has three outputs. A signal is provided for evaluating the current braking request. The other signal serves to store fault messages regarding the braking request. The third signal serves to evaluate the brake test. This division enhances the accuracy of the whole system. A diagnostic link 24 serves to read out detailed system information via an external device, e.g. a computer, which is connected to the device according to the invention via a serial interface.

The processor core of the system operates the above-described inputs and outputs, as well as the diagnostic link. The internal states of the system are communicated to the processor via special measuring elements of the electronic system in the high-current part. The processor has assigned thereto a separate monitoring module 13 configured as an IC, which, apart from the processor, also monitors the secondary voltages in the system.

The processor obtains information on the system status through the measuring points in the circuit of the magnets. With this information the processor generates the corresponding error signals and entries in the error memory for output via the diagnostic interface.

The evaluation method is divided into two sub-units, namely the diagnosis of the magnetic brake monitoring system and the monitoring of the braking function. The system diagnosis monitors, inter alia, the individual components of the high-current part. This can e.g. be carried out by voltage measurements. In general the following measuring/monitoring operations are carried out in this context:

1. Monitoring of the Voltage Supply of the Magnet

A low current is here generated between the connections of the battery and is evaluated in the monitoring element 10. Upon failure of at least one connection, e.g. failure of the fuse or a cable break, no current flow is possible and this is immediately detected.

2. Monitoring of the Electromechanical Separator 3

The voltage behind the separator 3 is measured by the detecting unit 14. If voltage is applied to the device, i.e. the conclusion is drawn from the measurement described under 1. that a current is generated between the connections, and no voltage is measured in the detecting unit 14, the separator 3 is open. A faulty position of the separator 3 can here be detected instantaneously.

3. Monitoring of the Current Flow through the Magnets

The current flow through the individual brake magnets 1, 2 is measured via current transformers 4, 5 or shunts. Depending on the magnetic circuit, the measurement is carried out on the detecting units 15, 16. The signal supplied by the sensor is subjected to low-pass filtering. The noise present on the battery supply system is thereby filtered out. The following system states can here be detected through measurement of the current:
if no current flow is measured, there is a line break in the connection of a brake magnet;
if a current flow is measured without the brake being switched on, there is a shorting in the connection of a brake magnet, or the associated switching element 8, 8 is defective;
a comparison between both magnets for plausibility check by the processor serves to determine the level of the absolute current.

4. Monitoring of the Suppressor Diodes 6, 7

The voltage of the suppressor diode in flow direction is measured by the detecting units 17, 18. During normal operation this voltage is low at the switch-off time, forward voltage of the current, but in case of fault a distinctly higher voltage peak is here created due to the interrupted suppressor circuit. A loss in blocking action is determined via the detecting units 15, 16 and/or 17, 18.

5. Monitoring of the Switching Elements 8, 9

The measurement of the voltages via the switching elements 8, 9, e.g. voltage between source and drain in the IGBT, is carried out via the detecting units 19, 20. When the voltage measured by the detecting units 18, 20 corresponds to the supply voltage, which was determined in the measurement described under 1., the corresponding switching element 8, 9 is switched off; no current is flowing. A small positive voltage in the low-voltage range is a measure of the current flowing through the element. Hence, the corresponding current sensor can also be monitored through the measurement 5.

In addition to the above-mentioned monitoring operations, the on-period may also be monitored.

With the beginning of the braking operation a waiting period is set, which corresponds to the longest activation period of the magnetic brake. After the waiting period has expired, the braking operation is completed under normal conditions; the triggering signal is canceled. If this signal is still applied after the end of the waiting period, a fault in the input circuit is assumed.

The processor is supplied with the information of the measuring elements and derives the error states therefrom. These are made known via the output lines to the master system and are additionally stored in a non-volatile error memory.

During railroad operation a brake test is carried out at regular intervals or in case of need, the evaluation of said test serving to infer the reliable placement of both brake magnets on the rails on the basis of the measurement values of the system diagnosis in the case of a requested brake test. Within the scope of this brake test the system is fully monitored and the current profile is recorded. A monitoring of the zero crossings, as well as a recording of the absolute values, is particularly carried out.

With the beginning of the brake test the electronic switches are closed. The current flow through the magnets builds up in conformity with the time constant of the brake magnets. In parallel therewith the brake magnets are lowered onto the rails. At the time when the magnets contact the rails, some current is already flowing through the brake magnets. Due to the iron of the rail the total inductance of the magnetic circuit of both brake magnets is changed. This process manifests itself in a reduction of the current flow through the brake magnets. Subsequently, the current will rise again until it has reached a constant end value. Said current profile with the typical sharp bend is shown in FIG. 2.

The reliable placement of the brake magnets on the rails can be deduced from this current profile. The placement of the brake magnets is checked during use in conformity with the evaluation of the brake test.

During operation, however, it cannot be ensured that the current profile will always correspond to the current profile of the brake test. For instance, wear of the brake magnets as well as impurities on the rails, or the like, have a sometimes considerable influence on the measurement values, so that an attenuated current profile is measured and, at the same time, the typical sharp bend is not so pronounced any more. Wear also exerts an influence on the brake test, so that the absolute values of the curves may differ from one another.

Therefore, according to the present invention the function of the brake is not directly determined on the basis of the values of the current profile, but the derivative of successive measurement values is formed. It is positive for a long time, very negative at the point of contact and then positive again. It becomes apparent from the derivative curve shown in FIG. 3 that the correct placement of the brake can be ensured through the presence of two zero crossings of the derivative curve. These zero crossings can also be detected in a definite way in the case of an attenuated current profile, so that a reliable monitoring operation is guaranteed. During use the difference (derivative) of successive measurement values is here reproduced. It is positive for a long time, very negative at the contact time and then positive again. A measure of the contact and distance between magnet and rail is the collapse in the current curve that manifests itself in the negative peak of the differential.

In addition, the minimum and maximum current can also be evaluated. Apart from this, the reached maximum of the curve is stored. When magnet and rail contact each other, the derivative of the curve is negative; the instantaneous measurement value is smaller than the previously reached maximum. In the course of time the current flow rises again and reaches or exceeds the maximum already determined before.

During operation the current flow is measured at time constant intervals of normally 10 milliseconds.

In addition to the monitoring of the magnetic brake on the basis of the current profile, the action of the magnetic brake can also be ensured by additional devices/methods that can be used in combination with the previously described monitoring device.

For instance, the magnetic brake can be monitored by an oscillating circuit in addition and at the same time. With the brake magnet as an element, an oscillating circuit is built up in this case. The different inductance in the raised and lowered states of the magnets yields different resonance frequencies of said oscillating circuit.

In addition, the brake magnet can also be provided with a position sensor. Said sensor senses the distance between itself and the rail head. If a certain distance falls below a value, this is interpreted as a placement on the rail head. A non-horizontal position can be detected via sensors at both ends of the magnet. Inductive, capacitive or optical sensors may serve as sensors.

Furthermore, a thermometer can be integrated into the brake magnet. When the brake is activated the current flow in the magnet effects the self-heating thereof. Upon contact of the magnet with the rail the vehicle is delayed via friction. The evolving heat is much greater than the self-heating by the current.

Furthermore, the temperature of the rail head in front of and behind the magnetic brake can be measured via a respective thermosensor. Upon braking the friction generates an increase in the rail temperature. The action of the brake can also be detected by comparison of the temperature in front of and behind the magnet. This arrangement has the advantage that the sensor is not mounted on the carrier of the magnet, but in the area protected by the primary suspension.

In addition to the above-mentioned monitoring methods, the monitoring operation can also be carried out on the basis of a comparing method. To this end, two measurements taken at a short interval are compared with each other. At the beginning of the braking operation the magnet is switched on. A current flow builds up. When a specific current flow has been reached, the magnet is switched off, so that the current is decreasing. After some time, after the magnet has normally reached the rail head, the magnets are switched on again. Current builds up again, the time constant of which is changed by the changed magnetic circuit. The comparison can be made on the basis of a comparison of the current curve shape or the time until a certain current flow has been reached. In the first-mentioned case a switching on in the lowered state of the magnet must exhibit a smaller current flow than the current in the raised state of the magnet. In the last-mentioned case the times until the achievement of a defined current flow are compared. That time is somewhat longer in the lowered state of a magnet.

1. A device for monitoring a magnetic brake on rail vehicles, the magnetic brake being connected to a source of voltage for current supply, the device comprising switching on and monitoring of the brake magnet current, and the monitoring device comprising a determining device and an evaluating device, the determining device continuously monitoring the function of the circuit for the current supply to the magnetic brake and recording the current and/or voltage profile,
characterized in that the evaluating device determines the placement of the magnetic brake on the rail on the basis of the recorded current and/or voltage profile by detection of two zero crossings of the first derivative of the current and/or voltage profile.

2. The device according to claim 1, characterized in that an electromechanical separator 3 is arranged as an emergency cutout in the circuit.

3. The device according to claim 1, characterized in that the determining device additionally monitors the individual elements of the circuit, particularly the electromechanical separator 3, the current sensors 4, 5, suppressor diodes 6, 7, and switching elements 8, 9.

4. The device according to claim 3, characterized in that the switching elements are IGBT modules.

5. The device according to claim 1, characterized in that each brake magnet comprises a position sensor.

6. The device according to claim 5, characterized in that the position sensor is an inductive, capacitive or optical sensor.

7. The device according to claim 1, characterized in that each brake magnet comprises a thermometer.

8. The device according to claim 1, characterized in that a thermosensor is arranged in front of and behind each brake magnet.

9. The device according to claim 1, characterized in that each brake magnet is arranged in a circuit of its own.

10. The device according to claim 1, characterized in that the device monitors a swivel truck with two magnets or a car with two swivel trucks.

11. A method for monitoring a magnetic brake on rail vehicles, comprising the continuous monitoring of the function of the circuit for current supply to the magnetic brake and recording the current and/or voltage profile,
characterized in that
on the basis of the recorded current and voltage profile the placement of the magnetic brake on the rail is determined by detection of two zero crossings of the first derivative of the current and/or voltage profile.

12. The method according to claim 11, characterized in that the current flow is measured at time constant intervals of 1 to 30 milliseconds.

13. The method according to claim 11, characterized in that the current path of each brake magnet is separately monitored.

14. The method according to claim 11, characterized in that the current is measured in the outgoing line and return line.

15. The method according to claim 11, characterized in that the supply voltage and/or the intrasystem voltages are cyclically measured in the magnetic circuit.

16. The method according to claim 11, characterized in that a report on the state and/or the general fault situation is transmitted to a master system.

17. The method according to claim 11, characterized in that the individual elements of the circuit are additionally monitored and a diagnosis of each individual element is carried out.
